(19) United States
(12) Patent Application Publication
(10) Pub. No.: US 2012/0213312 A1
(43) Pub. Date: Aug. 23, 2012

(54) WIRELESS TRANSMITTING APPARATUS, WIRELESS TRANSMITTING METHOD, AND WIRELESS TRANSMITTING PROGRAM

(75) Inventors: Yasunori FUTATSUGI, Tokyo (JP); Masayuki ARIYOSHI, Tokyo (JP)

(73) Assignee: NEC CORPORATION, Tokyo (JP)

(21) Appl. No.: 13/401,423

(22) Filed: Feb. 21, 2012

(30) Foreign Application Priority Data
Feb. 22, 2011 (JP) 2011-036233

(51) Int. Cl. H04L 25/49; H04B 15/00

(52) U.S. Cl. 375/296

(57) ABSTRACT

An interference suppression signal suppresses a leakage power caused by a transmission information symbol outside a desired transmission band. In a wireless transmitting apparatus, an interference suppression signal waveform shaping unit performs waveform shaping to the interference suppression signal while the interference suppression signal is separated from the transmission information symbol.

### TECHNICAL FIELD

The present application relates to a wireless transmitting apparatus, a wireless transmitting method, and a wireless transmitting program.

### BACKGROUND

In a next-generation wireless communication system, there is a risk that a frequency source is depleted due to broadband of a transmission rate and versatility of the system. Recently, there is studied a cognitive radio system in which a surrounding radio wave environment and needs of a user are recognized to autonomously conduct optimum communication based on the recognition result. In the cognitive radio field, a dynamic spectrum access method attracts attention from the viewpoint of effective utilization of the frequency source. In the dynamic spectrum access method, the frequency band allocated to the existing wireless system is secondarily used in another wireless system.

Specifically, in the dynamic spectrum access method, a secondary system that is of a new wireless system utilizes a free spectrum of the frequency band allocated to a primary system that is of the existing wireless system such that communication is not interrupted in the primary system.

FIG. 16 is an explanatory view illustrating an example of the communication system in which the dynamic spectrum access is performed. In the example illustrated in FIG. 16, a free spectrum of the frequency band allocated to a primary system 2210 is utilized by a secondary system 2220 such that the communication is not interrupted in the primary system 2210. That is, the frequency band allocated to an up-link or a down-link of the primary system 2210 is commonly used in the up-link or the down-link of the secondary system 2220.

In the example illustrated in FIG. 16, the primary system 2210 includes a base station 2211, a mobile station 2212, and a mobile station 2213. The base station 2211 transmits and receives data to and from the mobile station 2212 and the mobile station 2213.

The secondary system 2220 includes a base station 2221, a mobile station 2222, and a mobile station 2223. The base station 2221 transmits and receives data to and from the mobile station 2222 and the mobile station 2223. Using the free spectrum of the frequency band allocate to the primary system 2220, the base station 2221 and the mobile station 2222 of the secondary system 2220 conduct communication (transmit the data) such that the communication is not interrupted in the primary system 2210.

A dynamic spectrum access based on a standard Institute of Electrical and Electronics Engineers (IEEE) 802.22 WRAN (Wireless Regional Area Network) about a dynamic spectrum access can be cited as another example of the dynamic spectrum access. IEEE 802.22 is the standard in which a fixed wireless access system that is of the secondary system utilizes the free channel of the frequency band of terrestrial TV broadcasting that is of the primary system in the United States.

An interference suppression technique relating to the dynamic spectrum access will be described below. FIGS. 17A and 17B are explanatory views illustrating examples of an operating band of the primary system and a spectrum of the secondary system. FIG. 17A illustrates an example of a spectrum before the interference suppression technology is applied. FIG. 17B illustrates an example of the spectrum after the interference suppression technology is applied.

Basically, in the secondary system, there is a demand for conducting communication such that the communication is not interrupted in the primary system. Accordingly, in the secondary system, it is necessary for spectra 2302-1 and 2302-2 to be suppressed such that the spectra 2302-1 and 2302-2 do not interfere with operating bands 2301-1, 2301-2, and 2301-3 of the primary system. However, as illustrated in FIG. 17A, because a leakage power leaking outside a transmission band exists in the actual transmission spectrum, possibly part of the spectra of the secondary system interferes with the primary system.

The interference with the primary system is suppressed when a sufficient guard band is provided between the secondary system spectrum and a primary-system operating band on the secondary system side. However, possibly the sufficient guard band leads to degradation of frequency utilization efficiency.

As described above, in the cognitive radio system in which the same frequency band is commonly used by plural systems, when the data is transmitted in the secondary system, it is necessary that the interference with the primary system be suppressed while the frequency utilization efficiency is not degraded. In the case that the secondary system is one in which an OFDM (Orthogonal Frequency Division Multiplexing) based wireless access system is adopted, the leakage power leaking to the outside of the band is increased due to a sidelobe component of a sub-carrier. Therefore, it is necessary to take some sort of interference suppression countermeasure.

Examples of the interference suppression transmission system (method) for suppressing the interference with the primary system include a method in which a digital filter is used, a null reproducing method, a Gaussian multi-carrier method, sub-carrier waiting, time windowing, AIC (Active Interference Cancellation), and a CC (Cancellation Carrier).

In the method in which the digital filter is used, the spectrum is shaped by an FIR (Finite Impulse Response) filter or an IIR (Infinite Impulse Response) filter. In the null reproducing method, after plural OFDM symbols are combined, an FFT (Fast Fourier Transform) is performed to substitute a null sub-carrier. An IFFT (Inverse Fast Fourier Transform) is performed after the null sub-carrier is substituted. The Gaussian multi-carrier method is a multi-carrier transmission method in which the spectrum is shaped by a Gaussian pulse waveform. In the sub-carrier waiting, a symbol converted into a sub-carrier signal is weighted. In the time windowing, the OFDM symbol is shaped in the time domain. In the AIC and the CC, a tone is generated to cancel an out-of-band leakage component.

The AIC and the CC that have high affinity with a commercially available existing wireless system to be able to dynamically perform the interference suppression according to a surrounding radio wave condition will be described below. The AIC system and the CC system are uniformly described.

FIG. 18 is a block diagram illustrating a configuration example of a wireless transmitter that implements the CC system described in H. Yamaguchi, “Active Interference Cancellation technique for MB-OFDM cognitive radio”, 34th EMC, 2004, and S. Brandes, I. Cosovic, M. Schnell, “Sidelobe suppression in OFDM systems by Insertion of cancellation carriers”, VTC2005, 2005. The wireless transmitter illustrated in FIG. 18 is a transmitter in which the CC system is arranged, and the wireless transmitter includes a modulation unit 2401, a CC signal generating and inserting unit 2402, an inverse Fourier transform unit 2403, and a zero-padding inserting unit 2404.

The modulation unit 2401 inputs a transmission information bit stream, and performs modulation processing for mapping each bit of the input transmission information bit stream in a symbol (modulation symbol point) that is of a modulation unit. The modulation unit 2401 outputs a transmission information symbol obtained through the modulation processing to the CC signal generating and inserting unit 2402.

The CC signal generating and inserting unit 2402 inputs the transmission information symbol output from the modulation unit 2401. The CC signal generating and inserting unit 2402 calculates an interference suppression signal (CC signal) that suppresses the interference in a partial interference avoidance band near the transmission band in the interference avoidance band. The CC signal generating and inserting unit 2402 outputs the transmission information symbol in which the CC signal is inserted to the inverse Fourier transform unit 2403.

The inverse Fourier transform unit 2403 inputs the transmission information symbol in which the CC signal is inserted, and performs inverse Fourier transform processing to the input transmission information symbol. The inverse Fourier transform unit 2403 outputs the OFDM symbol generated through the inverse Fourier transform to the zero-padding inserting unit 2404.

The zero-padding inserting unit 2404 inputs the OFDM symbol generated through the inverse Fourier transform, and inserts a zero-padding (ZP) guard interval between the OFDM symbols. The zero-padding inserting unit 2404 outputs the OFDM symbol, in which the zero-padding guard interval is inserted, as a transmitting modulation signal.

FIG. 19 is a block diagram illustrating an example of the detailed configuration of the CC signal generating and inserting unit 2402. As illustrated in FIG. 19, the CC signal generating and inserting unit 2402 includes a copying unit 3001, a CC signal calculator 3002, and a CC signal inserting unit 3003.

The copying unit 3001 inputs the transmission information symbol from the modulation unit 2401 to copy the transmission information symbol. The copying unit 3001 outputs the copied transmission information symbol to the CC signal calculator 3002 and the CC signal inserting unit 3003.

The CC signal calculator 3002 inputs the transmission information symbol from the copying unit 3001 to calculate the CC signal that suppresses the interference. The CC signal calculator 3002 outputs the calculated CC signal to the CC signal inserting unit 3003.

The CC signal inserting unit 3003 inputs the transmission information symbol from the copying unit 3001, and inputs the CC signal from the CC signal calculator 3002. The CC signal inserting unit 3003 inserts the CC signal in the transmission information symbol. The CC signal inserting unit 3003 outputs the transmission information symbol in which the CC signal is inserted to the inverse Fourier transform unit 2403.

FIG. 20 is an explanatory view illustrating an example of the interference suppression by the CC system described in S. Brandes, I. Cosovic, M. Schnell, “Sidelobe suppression in OFDM systems by Insertion of cancellation carriers”, VTC2005, 2005. In FIG. 20, a horizontal axis indicates a frequency and a vertical axis indicates power density. FIG. 20 illustrates a relationship between a transmission band 2602 and a frequency position of an outside transmission band (interference avoidance band) 2601. FIG. 20 illustrates the transmission band 2602 and the interference avoidance band 2601. In the CC system, the secondary-system wireless transmitter sets an interference suppression signal (CC signal) 2603 in order to cancel a spectrum leakage component that leaks from the secondary-system transmission band 2602 to the interference avoidance band 2601. The CC signal 2603 corresponds to an AIC tone disclosed in H. Yamaguchi, “Active Interference Cancellation technique for MB-OFDM cognitive radio”, 34th EMC, 2004. The CC signal 2603 is generated such that the power is suppressed in part of the band near the transmission band 2602 in the interference avoidance band 2601, namely, the partial interference suppression band. FIG. 20 illustrates the example in which the two CC signals 2603 are set near the interference avoidance band 2601 in the transmission band 2602. The CC signal 2603 minimizes the leakage power leaking to the partial interference avoidance band in which the leakage power is particularly large in the interference avoidance band 2601. Accordingly, in the case that the interference avoidance band has the wide width, the leakage power can be suppressed compared with the AIC system. That is, the CC system can suitably be applied to the secondary-system transmitting apparatus in which the dynamic spectrum access is adopted.

Japanese Patent Application Laid-Open No. 2009-89393 also describes an example of the interference suppression processing by the AIC.

Problems of the AIC system and the CC system will be described. In the AIC system described in H. Yamaguchi, “Active Interference Cancellation technique for MB-OFDM cognitive radio”, 34th EMC, 2004 and the CC system described in S. Brandes, I. Cosovic, M. Schnell, “Sidelobe suppression in OFDM systems by Insertion of cancellation carriers”, VTC2005, 2005, the zero-padding guard interval is inserted between the CC signal OFDM symbols that are of the interference suppression signals in order to enhance the interference suppression effect. Therefore, discontinuity is increased between the CC signal OFDM symbols. As a result, interference power spectrum density is increased by the sidelobe component of the CC signal in the outside of the partial interference avoidance band in which the interference is suppressed.

An object of the application is to provide a wireless transmitting apparatus and a wireless transmitting method, which can further reduce the interference with the primary system.

### SUMMARY

A wireless transmitting apparatus according to an aspect of an illustrative embodiment includes interference suppression signal waveform shaping unit which performs waveform shaping to an interference suppression signal that suppresses a leakage power caused by a transmission information symbol outside a desired transmission band while separating the interference suppression signal and the transmission information symbol.

In a wireless transmitting method according to another aspect of an illustrative embodiment includes, waveform shaping is performed to an interference suppression signal that suppresses a leakage power caused by a transmission information symbol outside a desired transmission band while the interference suppression signal is separated from the transmission information symbol.

A computer readable information storage medium storing a program according to still another aspect of an illustrative embodiment includes causes a computer to perform processing of performing waveform shaping to an interference suppression signal that suppresses a leakage power caused by a transmission information symbol outside a desired transmission band while separating the interference suppression signal and the transmission information symbol.

According to mentioned aspects of the invention, the interference suppression effect can be obtained.

### BRIEF DESCRIPTION OF DRAWINGS

FIG. 1 is a block diagram illustrating a configuration example of a baseband unit 100 included in a wireless transmitting apparatus according to a first embodiment;

FIG. 2 is a flowchart illustrating an example of an operation of the baseband unit 100 of the first embodiment;

FIG. 3 is a block diagram illustrating a configuration example of a baseband unit 500 included in a wireless transmitting apparatus according to a second embodiment;

FIG. 4 is a block diagram illustrating an example of the detailed configuration example of the CC signal generating and separating unit 505;

FIG. 5 is a block diagram illustrating an example of the detailed configuration example of a CC signal calculator 1002;

FIG. 6 is an explanatory view schematically illustrating an output signal of a zero-padding inserting unit 507;

FIG. 7 is an explanatory view schematically illustrating an output signal of a cyclic extension unit 508;

FIG. 8 is an explanatory view schematically illustrating an output signal of a time windowing unit 509;

FIG. 9 is an input-signal pattern diagram illustrating an example of an input signal of an IFFT PROCESSING UNIT 506-1;

FIG. 10 is an input-signal pattern diagram illustrating an example of an input signal of an IFFT PROCESSING UNIT 506-2;

FIG. 11 is a flowchart illustrating an example of an operation of the baseband unit 500 of the second embodiment;

FIG. 12 is a block diagram illustrating a configuration example of a baseband unit 500′ included in a wireless transmitting apparatus according to a third embodiment;

FIG. 13 is an explanatory view illustrating an example of interference suppression of the third embodiment;

FIG. 14 is a block diagram illustrating an outline of the invention;

FIG. 15 is a block diagram illustrating an outline of the invention;

FIG. 16 is an explanatory view illustrating an example of a communication system that performs dynamic spectrum access;

FIG. 17A is an explanatory view illustrating examples of an operating band of a primary system and a spectrum of a secondary system before an interference suppression technology is applied;

FIG. 17B is an explanatory view illustrating examples of the operating band of the primary system and the spectrum of the secondary system after the interference suppression technology is applied;

FIG. 18 is a block diagram illustrating a configuration example of a wireless transmitter that implements a CC system;

FIG. 19 is a block diagram illustrating a configuration of a CC signal generating and inserting unit 2402; and

FIG. 20 is an explanatory view illustrating an example of interference suppression by a CC system described in S. Brandes, I. Cosovic, M. Schnell, “Sidelobe suppression in OFDM systems by Insertion of cancellation carriers”, VTC2005, 2005.

### DESCRIPTION OF ILLUSTRATIVE EMBODIMENTS

Hereinafter, illustrative embodiments of the invention will be described below with reference to the drawings. In an illustrative embodiment, it is assumed that the OFDM is applied to the wireless access system. In an illustrative embodiment, a wireless transmitting apparatus of the invention is applied to the secondary system transmitter.

### First Embodiment

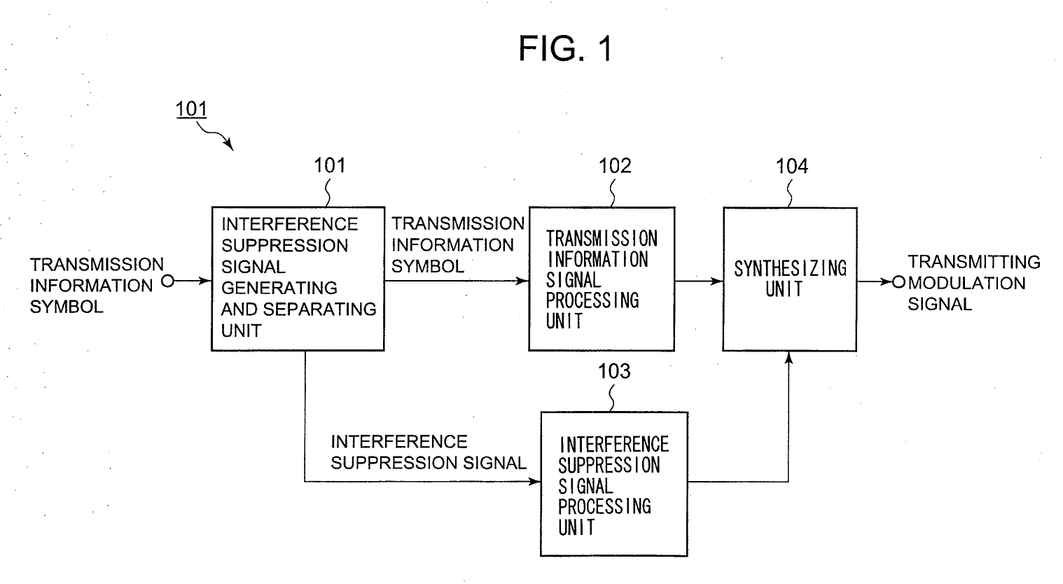

FIG. 1 is a block diagram illustrating a configuration example of a baseband unit 100 included in a wireless transmitting apparatus according to a first embodiment of the invention to perform digital processing. Generally the baseband unit 100 is located at a preceding stage of an RF unit. The baseband unit 100 inputs a transmission information bit stream, generates a transmitting modulation signal through digital processing, and outputs the transmitting modulation signal. In the first embodiment, the interference suppression processing is performed when the transmitting modulation signal is generated in the baseband unit 100.

As illustrated in FIG. 1, the baseband unit 100 includes an interference suppression signal generating and separating unit 101, a transmission information signal processing unit 102, an interference suppression signal processing unit 103, and a synthesizing unit 104.

The interference suppression signal generating and separating unit 101 inputs a modulated transmission information symbol, and generates an interference suppression signal through processing in a frequency domain. The interference suppression signal generating and separating unit 101 may use the CC system as an interference suppression signal generating system through the processing in the frequency domain. For example, the interference suppression signal generating and separating unit 101 generates the interference suppression signal such that interference is suppressed in a partial interference avoidance band near a transmission band in an interference avoidance band. The interference suppression signal generating and separating unit 101 outputs the input transmission information symbol to the transmission information signal processing unit 102, and outputs the generated interference suppression signal to the interference suppression signal processing unit 103. That is, the interference suppression signal generating and separating unit 101 does not insert the interference suppression signal in the input transmission information symbol, but outputs the input transmission information symbol to a processor in a subsequent stage and outputs the generated interference suppression signal to another processor in a subsequent stage.

The transmission information signal processing unit 102 inputs the transmission information symbol, which is output from the interference suppression signal generating and separating unit 101, to perform predetermined signal processing (hereinafter referred to as first signal processing). The symbol signal processing includes processing of mapping the transmission information symbol in a transmitted frequency. For example, the first signal processing is inverse Fourier transform processing. The first signal processing may also include signal processing such as zero-padding inserting processing. Thus, the “first signal processing” is not limited to one piece of processing, but may be processing implemented by a series of pieces of signal processing to the transmission information symbol. The transmission information signal processing unit 102 outputs a signal (hereinafter referred to as transmission information signal), in which the first signal processing is performed to the transmission information symbol, to the synthesizing unit 104.

The interference suppression signal processing unit 103 inputs the interference suppression signal, which is output from the interference suppression signal generating and separating unit 101, to perform predetermined signal processing (hereinafter referred to as second signal processing) including waveform shaping to the interference suppression signal. The second signal processing includes at least processing of mapping interference suppression signal in the transmitted frequency and processing of performing waveform shaping to the frequency-mapped interference suppression signal. The “second signal processing” may be performed by one section, or a section in which a frequency mapping function is implemented and a section in which a waveform shaping function is implemented. For example, in the second signal processing, inverse Fourier transform processing is used as the frequency mapping processing, and cyclic extension processing and time windowing processing are used as the waveform shaping processing. Thus, the “second signal processing” is not limited to one piece of processing, but may be processing performed by a series of pieces of signal processing to the interference suppression signal. The interference suppression signal processing unit 103 outputs a signal (hereinafter referred to as a waveform shaping interference suppression signal), in which the second signal processing is performed to the interference suppression signal, to the synthesizing unit 104.

The synthesizing unit 104 inputs the transmission information signal output from the transmission information signal processing unit 102 and the waveform shaping interference suppression signal output from the interference suppression signal processing unit 103, and synthesizes the transmission information signal output and the waveform shaping interference suppression signal. The synthesizing unit 104 outputs the synthesized signal as the transmitting modulation signal.

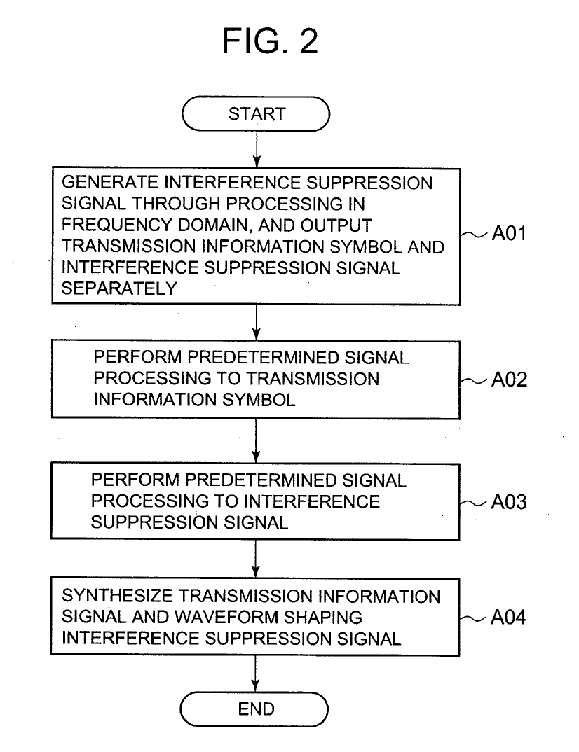

FIG. 2 is a flowchart illustrating an example of an operation relating to the interference suppression processing of the baseband unit 100. As illustrated in FIG. 2, when the modulated transmission information symbol is input, the interference suppression signal generating and separating unit 101 generates the interference suppression signal by performing the processing to the input transmission information symbol in the frequency domain, and the interference suppression signal generating and separating unit 101 outputs the input transmission information symbol and the generated interference suppression signal while separating the transmission information symbol and the interference suppression signal (Operation A01).

The transmission information signal processing unit 102 inputs the transmission information symbol output from the interference suppression signal generating and separating unit 101, performs the first signal processing, and outputs the signal (that is, transmission information signal) to which the signal processing is performed to the synthesizing unit 104 (Operation A02).

The interference suppression signal processing unit 103 inputs the interference suppression signal output from the interference suppression signal generating and separating unit 101, performs the first signal processing including the waveform shaping, and outputs the signal (that is, waveform shaping interference suppression signal) to which the signal processing is performed to the synthesizing unit 104 (Operation A03).

The synthesizing unit 104 inputs the transmission information signal output from the transmission information signal processing unit 102 and the waveform shaping interference suppression signal output from the interference suppression signal processing unit 103, and synthesizes the transmission information signal and the waveform shaping interference suppression signal (Operation A04). The synthesizing unit 104 outputs the synthesized signal as the transmitting modulation signal.

In the interference suppression signal generating and separating unit 101, the method for calculating the interference suppression signal may be identical to the method described in S. Brandes, I. Cosovic, M. Schnell, “Sidelobe suppression in OFDM systems by Insertion of cancellation carriers”, VTC2005, 2005. That is, for example, the interference suppression signal generating and separating unit 101 calculates the interference suppression signal such that a leakage power of the partial interference avoidance band is suppressed.

There is no limitation to the sequence of the pieces of processing in Operations A02 and A03. For example, the sequence of the pieces of processing in Operations A02 and A03 may be reversed. The sequence of the pieces of processing in Operations A02 and A03 may concurrently be performed.

In the first embodiment, because the interference suppression signal is waveform-shaped while separated from the transmission information symbol, the interference generated by the sidelobe component of the interference suppression signal is reduced. That is, an interference suppression effect can also be acquired outside the partial interference avoidance band in addition to the interference-suppressed partial interference avoidance band, and the interference with the primary system is further reduced.

When an amount of interference with the primary system is maintained at a constant level, an increase of transmitting power of the secondary system is suppressed, or a spatial distance between the primary system and the secondary system is decreased.

### Second Embodiment

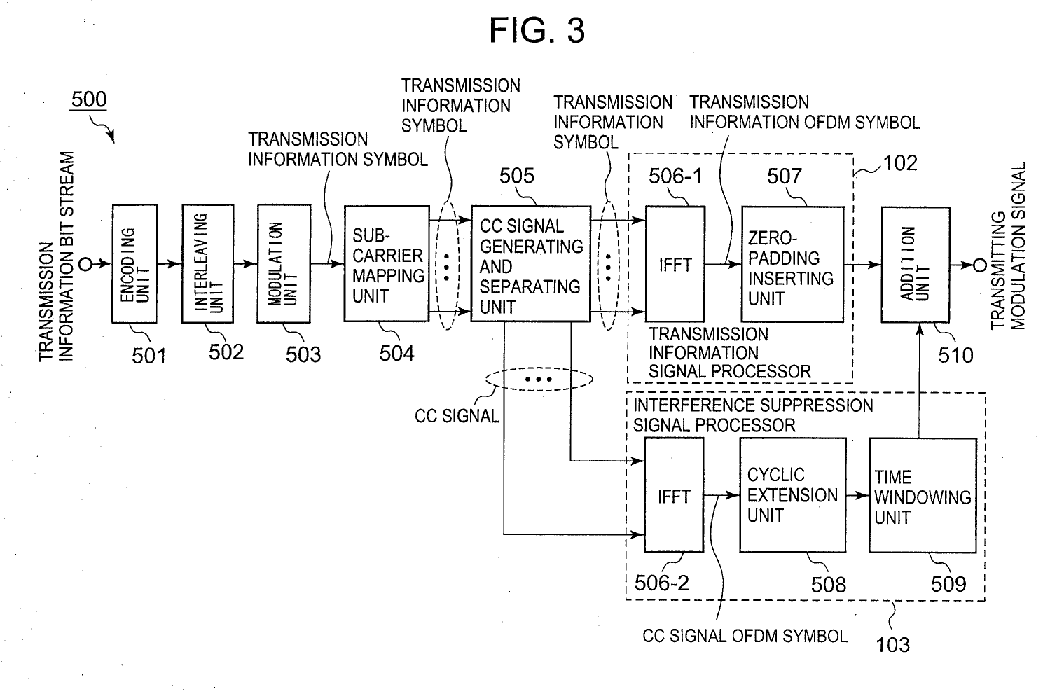

A second embodiment of the invention will be described below with reference to the drawings. FIG. 3 is a block diagram illustrating a configuration example of a baseband unit 500, which is included in a wireless transmitting apparatus according to a second embodiment to perform digital processing. The baseband unit 500 illustrated in FIG. 3 includes an encoding unit 501, an interleaving unit 502, a modulation unit 503, a sub-carrier mapping unit 504, a CC signal generating and separating unit 505, IFFT (Inverse Fast Fourier Transform) processing units 506-1 and 506-2, a zero-padding inserting unit 507, a cyclic extension unit 508, a time windowing unit 509, and an addition unit 510.

The encoding unit 501 inputs the transmission information bit stream, performs error correction coding processing, and outputs the coded bit stream to the interleaving unit 502. For example, the encoding unit 501 uses a convolution code or a turbo code in the coding processing.

The interleaving unit 502 inputs the coded bit stream from the encoding unit 501, performs interleaving processing of changing a bit array, and outputs the interleaved bit stream to the modulation unit 503.

The modulation unit 503 inputs the bit stream from the interleaving unit 502 to perform modulation processing of mapping the bit stream in a symbol. The modulation unit 503 outputs the modulated transmission information symbol to the sub-carrier mapping unit 504.

The sub-carrier mapping unit 504 inputs the transmission information symbol output from the modulation unit 503, performs serial/parallel (S/P) conversion to convert the input transmission information symbol into a parallel signal having a predetermined unit (for example, transmission frame unit), and performs the frequency mapping to the transmission information symbol such that the transmission information symbol corresponds to the transmitting sub-carrier. The sub-carrier mapping unit 504 outputs the frequency-mapped transmission information symbol to the CC signal generating and separating unit 505.

The CC signal generating and separating unit 505 inputs the frequency-mapped transmission information symbol output from the sub-carrier mapping unit 504. The CC signal generating and separating unit 505 performs processing to the input transmission information symbol in the frequency domain, thereby generating a CC signal (interference suppression signal) such that the interference power is reduced in the partial interference avoidance band. The CC signal generating and separating unit 505 outputs the transmission information symbol to the IFFT PROCESSING UNIT 506-1, and outputs the generated CC signal to the IFFT PROCESSING UNIT 506-2.

The IFFT PROCESSING UNIT 506-1 inputs the transmission information symbol output from the CC signal generating and separating unit 505. The IFFT PROCESSING UNIT 506-1 generates an OFDM symbol by performing IFFT processing (Inverse Fast Fourier Transform processing) to the input transmission information symbol. The IFFT PROCESSING UNIT 506-1 outputs the generated transmission information OFDM symbol to the zero-padding inserting unit 507.

The zero-padding inserting unit 507 inputs the transmission information OFDM symbol output from the IFFT PROCESSING UNIT 506-1. The zero-padding inserting unit 507 inserts a zero-padding guard interval between the input transmission information OFDM symbols. The zero-padding inserting unit 507 outputs the OFDM symbol in which the zero-padding guard interval is inserted to the addition unit 510.

The IFFT PROCESSING UNIT 506-2 inputs the CC signal output from the CC signal generating and separating unit 505. The IFFT PROCESSING UNIT 506-2 generates a CC signal OFDM symbol by performing the IFFT processing to the input CC signal. The IFFT PROCESSING UNIT 506-2 outputs the generated CC signal OFDM symbol to the cyclic extension unit 508.

The cyclic extension unit 508 inputs the CC signal OFDM symbol output from the IFFT PROCESSING UNIT 506-2. The cyclic extension unit 508 performs cyclic extension processing of extending the OFDM symbol in a time domain. The cyclic extension unit 508 outputs the extended OFDM symbol to which the cyclic extension processing is performed to the time windowing unit 509.

The time windowing unit 509 inputs the extended OFDM symbol output from the cyclic extension unit 508, and performs the waveform shaping to the extended OFDM symbol through window function processing in the time domain. The time windowing unit 509 outputs the waveform-shaped extended OFDM symbol to the addition unit 510.

The addition unit 510 inputs the OFDM symbol, which is output from the zero-padding inserting unit 507 while the zero-padding guard interval is added, and the extended OFDM symbol, which is output from the time windowing unit 509 while waveform-shaped. The addition unit 510 adds the input signals and outputs the sum as the transmitting modulation signal.

In the second embodiment, the IFFT PROCESSING UNIT 506-1 and the zero-padding inserting unit 507 are demonstrated as the more specific example of the transmission information signal processing unit 102 in the first embodiment. Also the IFFT PROCESSING UNIT 506-2, the cyclic extension unit 508, and the time windowing unit 509 are demonstrated as the more specific example of the interference suppression signal processing unit 103 in the first embodiment.

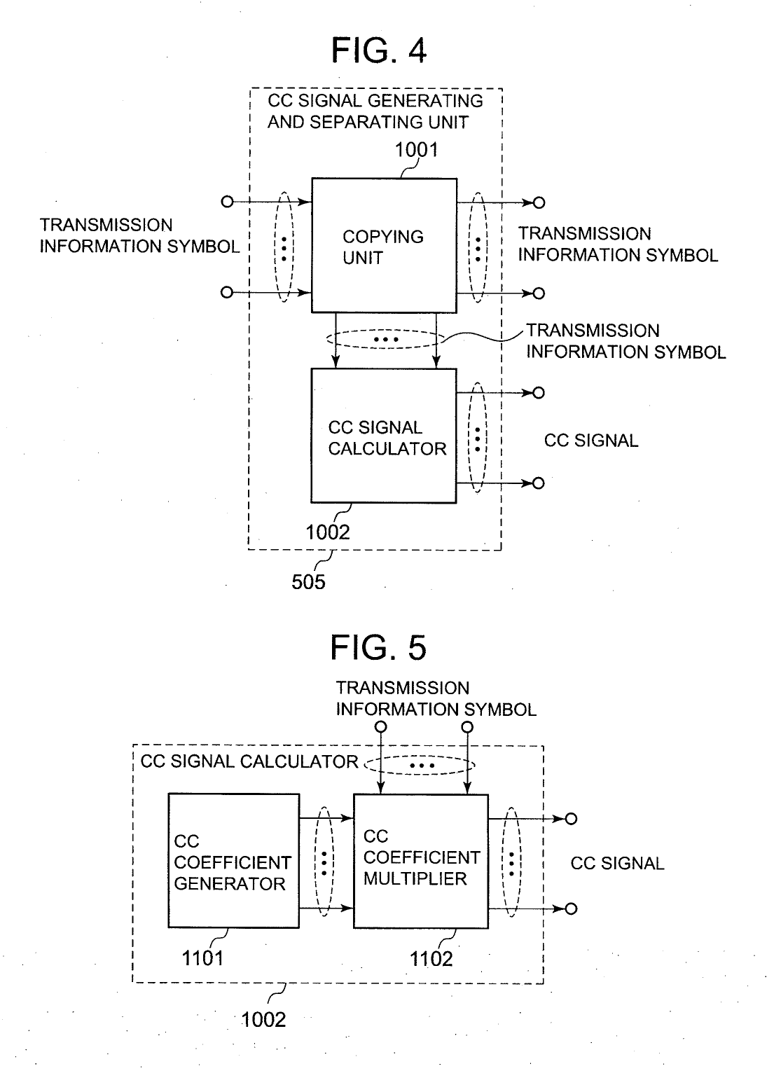

FIG. 4 is a block diagram illustrating an example of the detailed configuration of the CC signal generating and separating unit 505. As illustrated in FIG. 4, the CC signal generating and separating unit 505 may include a copying unit 1001 and a CC signal calculator 1002.

The copying unit 1001 inputs the frequency-mapped transmission information symbol output from the sub-carrier mapping unit 504, and copies the input transmission information symbol. The copying unit 1001 outputs one (for example, input transmission information symbol) of the transmission information symbols that become two by the copy to the IFFT PROCESSING UNIT 506-1, and outputs the other transmission information symbol (for example, the transmission information symbol generated by the copy) to the CC signal calculator 1002.

The CC signal calculator 1002 inputs the transmission information symbol that is output from the copying unit 1001. Based on the transmission information symbol, the CC signal calculator 1002 calculates and generates the CC signal such that the interference is suppressed in the partial interference avoidance band. The CC signal calculator 1002 outputs the generated CC signal to the IFFT PROCESSING UNIT 506-2.

FIG. 5 is a block diagram illustrating an example of the detailed configuration of the CC signal calculator 1002. As illustrated in FIG. 5, the CC signal calculator 1002 may include a CC coefficient generator 1101 and a CC coefficient multiplier 1102.

The CC coefficient generator 1101 calculates a CC coefficient and outputs the calculated CC coefficient to the CC coefficient multiplier 1102. For example, the CC coefficient corresponds to a matrix W of a later-described equation (7). There is no particular limitation to timing in which the CC coefficient generator 1101 generates the CC coefficient as long as the CC coefficient is generated after a frequency position at which the interference suppression is performed is determined. For example, when calculating the CC signal, the CC coefficient generator 1101 inputs the frequency position at which the interference suppression is performed by the CC signal for calculation. However, in a system in which the frequency position at which the interference suppression is performed is previously determined, the CC coefficient corresponding to the frequency position may previously be calculated.

The CC coefficient multiplier 1102 inputs the CC coefficient from the CC coefficient generator 1101, inputs the transmission information symbol from the copying unit 1001, and multiplies the CC coefficient and the transmission information symbol to generate the CC signal. The CC coefficient multiplier 1102 outputs the generated CC signal to the IFFT PROCESSING UNIT 506-2. For example, the CC signal is calculated using a later-described equation (7).

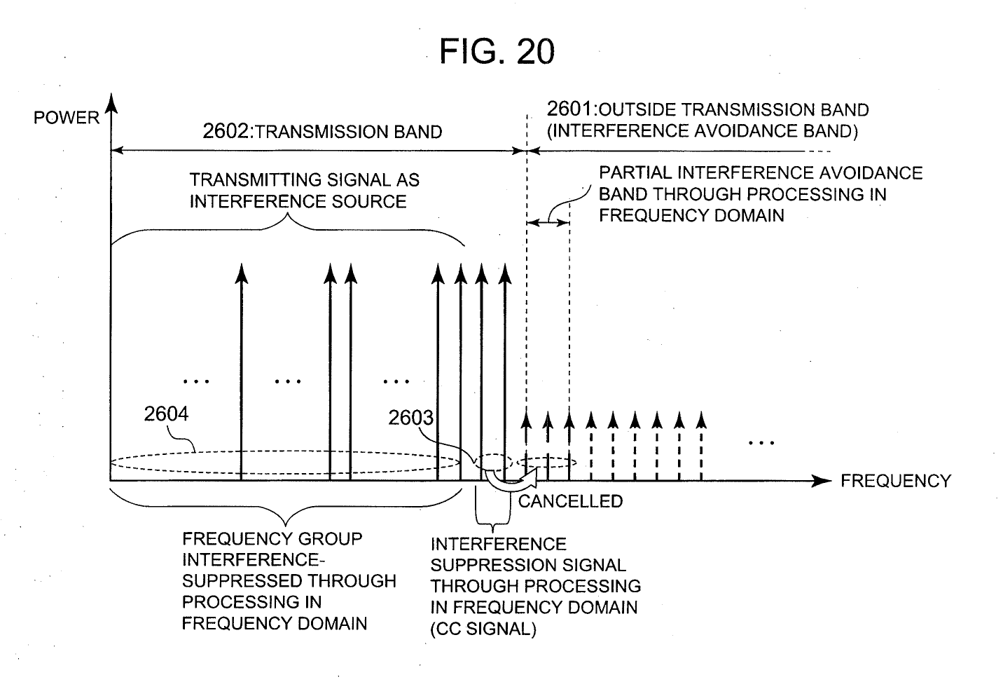

An example of a CC signal generating equation in the CC signal calculator 1002 will be described with reference to the example of the transmission band and the interference avoidance band, which are illustrated in FIG. 20. In the example illustrated in FIG. 20, the interference suppression is performed to a transmitting sub-carrier 2604 in the transmission band 2602 using the CC signal. In the interference suppression using the CC signal, the N_{CC} CC signals 2603 are inserted in the transmission band 2602 adjacent to the interference avoidance band 2601. The CC signal 2603 suppresses the partial interference avoidance band corresponding to the Nᵢ_{_{—}}ₚₐᵣₜᵢₐₗ sub-carriers adjacent to the transmission band 2602 in the interference avoidance band 2601 corresponding to the Nᵢ sub-carriers.

An OFDM signal x(n) of a sample n (n=0, 1, . . . , N−1) in the time domain, which is of the output of the IFFT PROCESSING UNIT 506-2, is expressed by the following equation (1)

$$x ( n ) = {\sum }_{k = 0}^{N - 1} X ( k ) exp ( j2π \frac{nk}{N} ) \qquad equation ( 1 )$$

In the equation (1), X(k) and k (k=0, 1, . . . , N−1) designate transmitted symbols. N designates a FFT size of the IFFT.

A spectrum Y(l) of the OFDM signal in a frequency position l (l=0, 1, . . . , NM−1), which is upsampled m times (M≧1), is expressed by the following equation (2).

$$Y ( l ) = \frac{1}{N} {\sum }_{n = 0}^{N - 1} x ( n ) exp ( - j2π \frac{n}{N} \frac{l}{M} ) \qquad equation ( 2 )$$

The spectrum Y(l) of the OFDM signal is expressed by the following equation (3) from the equations (1) and (2). In the equation (3), P(l,k) designates a transform kernel.

$$Y ( l ) = \frac{1}{N} {\sum }_{n = 0}^{N - 1} {\sum }_{k = 0}^{N - 1} X ( k ) exp ( j 2 π \frac{n}{N} ( k - \frac{l}{M} ) ) = \frac{1}{N} {\sum }_{k = 0}^{N - 1} X ( k ) P ( l , k ) \qquad equation ( 3 )$$

It is assumed that Nᵢ is the number of sub-carriers before the upsampling in the interference avoidance band, and it is assumed that Nᵢ_{_{—}}ₚₐᵣₜᵢₐₗ Nᵢ_{_{—}}ₚₐᵣₜᵢₐₗ<Nᵢ) is the number of sub-carriers before the upsampling in the partial interference avoidance band where the interference power is minimized by the CC signal in the interference avoidance band. Therefore, a column vector d₁ having a sidelobe component of (M (Nᵢ_{_{—}}ₚₐᵣₜᵢₐₗ−1)+1) rows after the upsampling in the partial interference avoidance band is expressed by the following equation (4).

d₁=P_{S}g equation (4)

In the equation (4), P_{S} designates a submatrix of a matrix P having the element P(l,k). The submatrix is a (M(Nᵢ_{_{—}}ₚₐᵣₜᵢₐₗ−1)+1)*N matrix in which Mu to M (u+Nᵢ_{_{—}}ₚₐᵣₜᵢₐₗ−1) rows corresponding to the sidelobe component after the upsampling in the partial interference avoidance band is extracted from the matrix P. g designates an N-row column vector including the transmission information symbol in which components corresponding to the interference avoidance band and the CC signal are eliminated. u designates a starting sub-carrier number of the partial interference avoidance band before the upsampling.

A signal that cancels the sidelobe component in the partial interference avoidance band is expressed by the following equation (5).

P₁h=−d₁ equation (5)

Assuming that N_{CC} is the number of CC signals, P₁ is the submatrix of the matrix P_{S} in which only the row corresponding to the partial interference avoidance band is considered. The submatrix is a (M(Nᵢ_{_{—}}ₚₐᵣₜᵢₐₗ−1)+1)*(Nᵢ_{_{—}}ₚₐᵣₜᵢₐₗ+N_{CC}) matrix in which u−N_{CC} to u+Nᵢ_{_{—}}ₚₐᵣₜᵢₐₗ−1 columns are extracted from the matrix P_{S}. h designates a (Nᵢ_{_{—}}ₚₐᵣₜᵢₐₗ+N_{CC})−row column vector of the CC signal that cancels the interference component.

Because the matrix P₁ is not a square matrix, the column vector h is obtained by a least-square error method. For example, based on the equation (5), a square error e² is expressed by the following equation (6).

e²=∥P₁h+d₁∥² equation (6)

Based on the equation (6), the column vector h that cancels the interference component is expressed by the following equation (7).

h=−(P₁^{T}P₁)⁻¹P₁^{T}d₁=−(P₁^{T}P₁)⁻¹P₁^{T}Pₛg=−Wg equation (7)

W is a (Nᵢ_{_{—}}ₚₐᵣₜᵢₐₗ+N_{CC})*N matrix and corresponds to the output signal of the CC coefficient generator 1101. As described above, the column vector h of the CC signal that cancels the interference component is calculated from the matrix W and the column vector g of the transmission information symbol. The column vector h of the CC signal corresponds to the output of the CC coefficient multiplier 1102. The column vector h of the CC signal includes (Nᵢ_{_{—}}ₚₐᵣₜᵢₐₗ+N_{CC}) elements, and the CC signal may be a signal including only elements corresponding to N_{CC}.

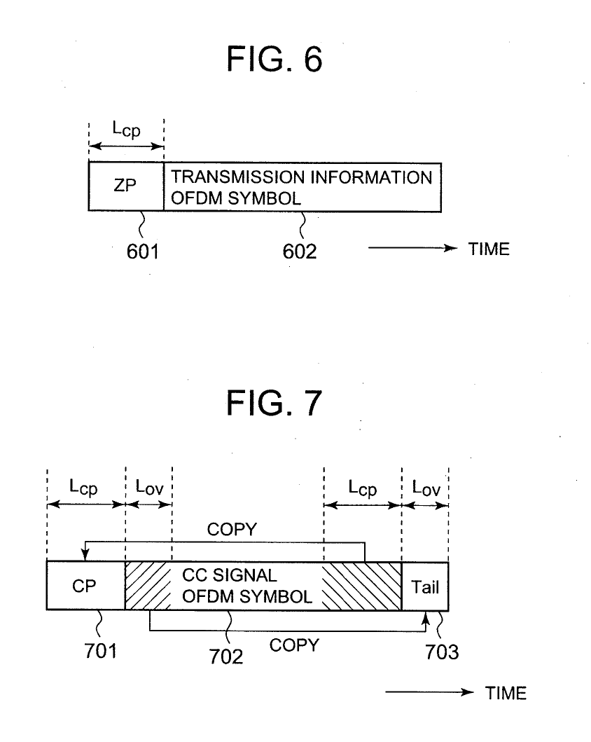

FIG. 6 is an explanatory view schematically illustrating an output signal of the zero-padding inserting unit 507. As illustrated in FIG. 6, the zero-padding inserting unit 507 adds a zero-padding guard interval (ZP) 601 having a cyclic prefix (CP) length (L_{CP}) [sample] to a head of the input transmission information OFDM symbol 602.

FIG. 7 is an explanatory view schematically illustrating the output signal of the cyclic extension unit 508. As illustrated in FIG. 7, the cyclic extension unit 508 adds a portion of the L_{CP} length in a rear portion of the CC signal OFDM symbol to the head of the OFDM symbol. The signal (the copy of the rear portion (L_{CP}) in the OFDM symbol) added to the head of the OFDM symbol is referred to as CP 701. The cyclic extension unit 508 further adds a window overlapping length (L_{OV}) [sample] in a front portion in the OFDM symbol to an end of the OFDM symbol. The signal (the copy of the front portion (L_{OV}) in the OFDM symbol) added to the end of the OFDM symbol is referred to as tail 703.

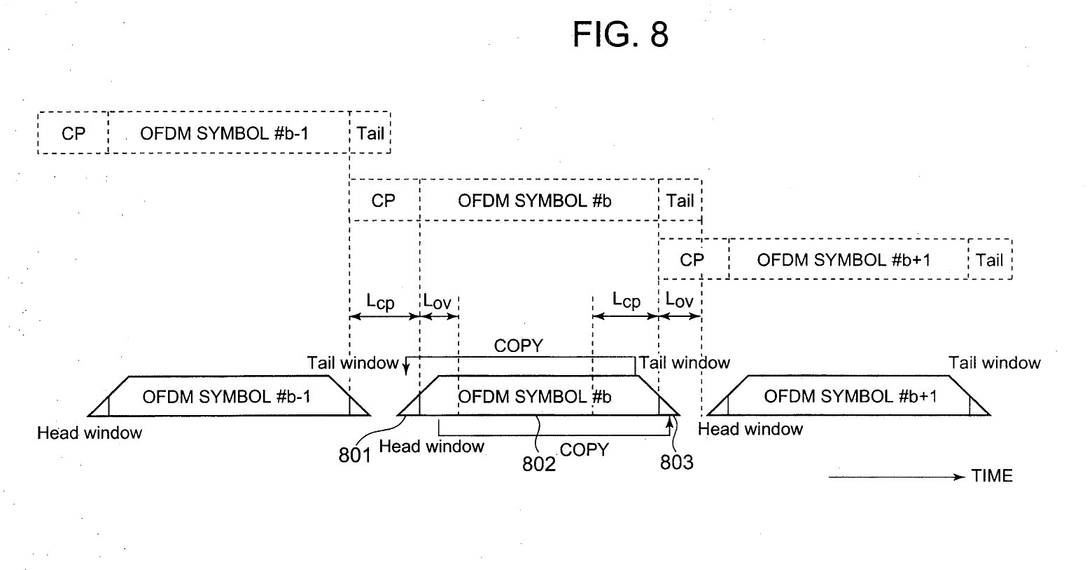

FIG. 8 is an explanatory view schematically illustrating the output signal of the time windowing unit 509. As illustrated in FIG. 8, in the time domain, the time windowing unit 509 performs the waveform shaping to both ends of the OFDM symbol extended by the cyclic extension unit 508. Waveform shaping based on a raised-cosine roll-off waveform satisfying a first reference of Nyquist can be cited as the waveform shaping. The time windowing unit 509 may perform the waveform shaping to an OFDM symbol interval at a previous stage of the cyclic extension. The time windowing unit 509 may perform the waveform shaping such that a zero-cross position of a frequency response of the waveform-shaped OFDM symbol is matched with a zero-cross position of a frequency response of the OFDM symbol to which the zero-padding guard interval (ZP) illustrated in FIG. 6 is added.

For example, the waveform-shaped signal may be a signal in which a CP interval (head window 801) of the OFDM symbol overlaps a part of a tail interval (tail window 803) of the forward OFDM symbol. The waveform-shaped signal may be a signal in which the tail interval of the OFDM symbol overlaps a part of the CP interval of the rearward OFDM symbol.

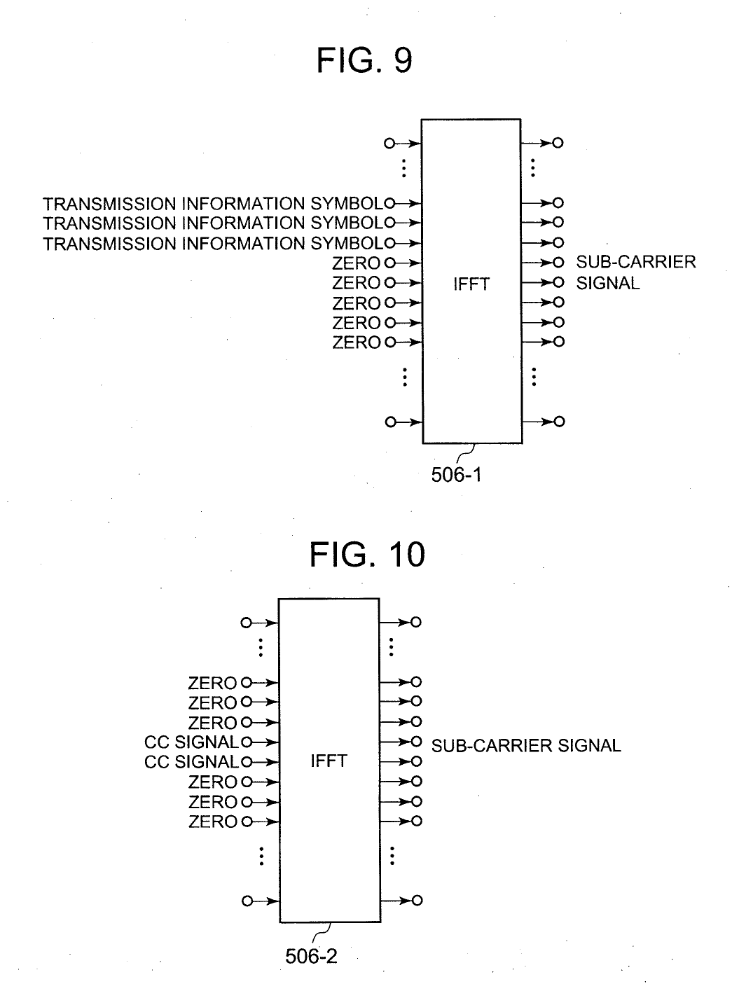

FIG. 9 is an input-signal pattern diagram illustrating an example of the input signal of the IFFT PROCESSING UNIT 506-1. FIG. 9 illustrates an example in which only the transmission information symbols are input while zeros are inserted in the symbols corresponding to the CC signal and the symbols corresponding to the interference avoidance band.

FIG. 10 is an input-signal pattern diagram illustrating an example of the input signal of the IFFT PROCESSING UNIT 506-2. FIG. 10 illustrates an example in which only the CC signals are input while zeros are inserted in the transmission information symbols and the symbols corresponding to the interference avoidance band.

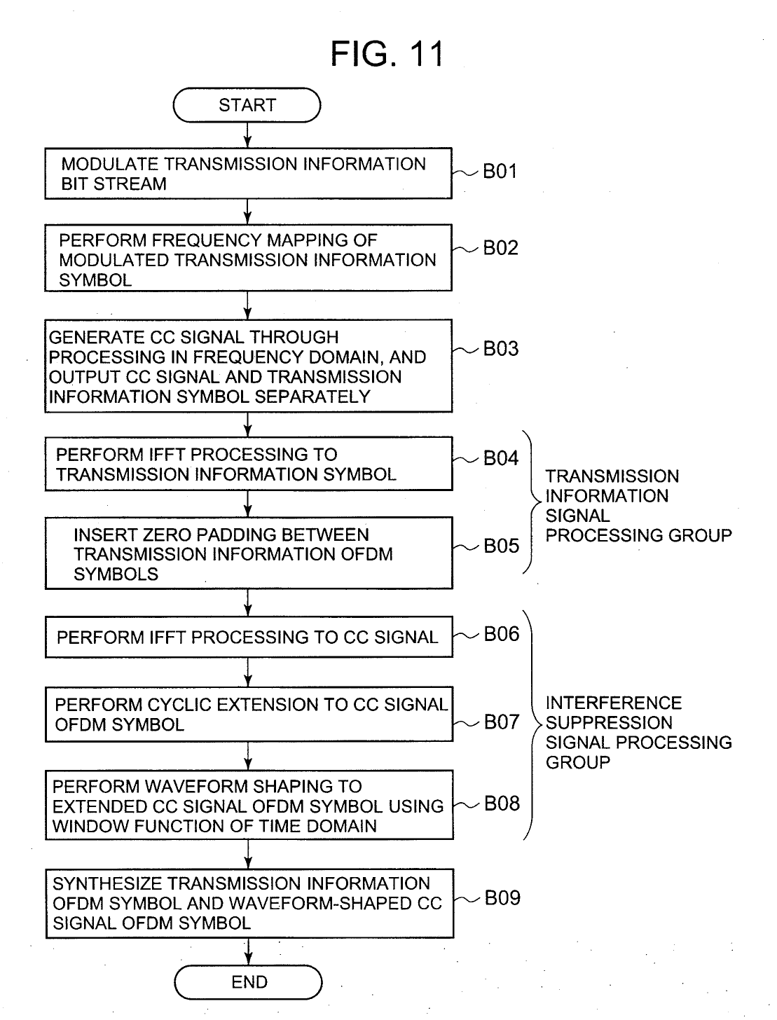

An operation of the second embodiment will be described below. FIG. 11 is a flowchart illustrating an example of the operation of the baseband unit 500 of the second embodiment. In the example illustrated in FIG. 11, the modulation unit 503 inputs the coded and interleaved bit stream to generate the modulated symbol (Operation B01).

The sub-carrier mapping unit 504 inputs the modulated transmission information symbol from the modulation unit 503, and performs S/P conversion of the input transmission information symbol to perform the frequency mapping (Operation B02).

The CC signal generating and separating unit 505 inputs the frequency-mapped transmission information symbol from the sub-carrier mapping unit 504. Based on the input transmission information symbol, the CC signal generating and separating unit 505 generates the CC signal that suppresses the interference in the partial interference avoidance band near the transmission band in the interference avoidance band. The CC signal generating and separating unit 505 outputs the input transmission information symbol and the generated CC signal while the transmission information symbol and the CC signal are separated (Operation B03).

The IFFT PROCESSING UNIT 506-1 inputs the transmission information symbol from the CC signal generating and separating unit 505 and performs the IFFT processing to the transmission information symbol (Operation B04).

When the IFFT PROCESSING UNIT 506-1 completes the IFFT processing, the zero-padding inserting unit 507 inputs the OFDM symbol from the IFFT PROCESSING UNIT 506-1 and inserts the zero-padding guard interval between the OFDM symbols (Operation B05).

The IFFT PROCESSING UNIT 506-2 inputs the CC signal from the CC signal generating and separating unit 505 and performs the IFFT processing to the CC signal (Operation B06).

When the IFFT PROCESSING UNIT 506-2 completes the IFFT processing, the cyclic extension unit 508 inputs the OFDM symbol from the IFFT PROCESSING UNIT 506-2 and extends the OFDM symbol through the cyclic extension processing (Operation B07).

The time windowing unit 509 inputs the extended OFDM symbol from the cyclic extension unit 508 and performs the waveform shaping to the extended OFDM symbol using the window function in the time domain (Operation B08).

When the processing of inserting the zero-padding guard interval in the transmission information OFDM symbol, which is performed by the zero-padding inserting unit 507, and the processing of performing the waveform shaping to the CC signal extended OFDM symbol, which is performed by the time windowing unit 509, are completed, the addition unit 510 inputs the OFDM symbol in which the zero-padding guard interval is inserted from the zero-padding inserting unit 507, inputs the waveform-shaped extended OFDM symbol from the time windowing unit 509, and performs synthesizing processing of adding the OFDM symbol and the extended OFDM symbol (Operation B09).

There is no limitation to the performance sequence of the pieces of signal processing (transmission information signal processing group) performed to the transmission information symbol in Operations B04 and B05 and the pieces of signal processing (interference suppression signal processing group) performed to the CC signal in Operations B06 to B08. For example, the transmission information signal processing group in Operations B04 and B05 may be performed after the interference suppression signal processing group in Operations B06 to B08. The transmission information signal processing group in Operations B04 and B05 and the interference suppression signal processing group in Operations B06 to B08 may concurrently be performed.

The interference suppression transmission system in which the processing is performed to the transmission information OFDM symbol in the frequency domain is not limited to the CC system, but another system may be adopted. The interference suppression transmission system in which the processing is performed to the CC signal OFDM symbol is not limited to the time windowing, but another system may be adopted.

As described above, in the second embodiment, the CC signal is processed using the window function, whereby discontinuity is reduced in the time domain of the CC signal while the zero crossing of the sidelobe component of the transmitting sub-carrier that is the interference source and the sidelobe component of the CC signal is maintained on a frequency axis. Therefore, the interference suppression effect is also obtained outside the partial interference avoidance band while the interference suppression effect by the CC signal in the partial interference avoidance band is maintained.

In the case that a general technique is used, the zero-padding guard interval is inserted in the CC signal in order that the zero crossing of the sidelobe component of the transmitting sub-carrier that is the interference source and the sidelobe component of the CC signal is established on the frequency axis to enhance the interference suppression effect. In the second embodiment, the zero padding is not inserted in the CC signal, but the cyclic extension and the waveform shaping are performed to maintain the zero crossing on the frequency axis. As a result, the interference suppression effect is enhanced in the partial interference avoidance band while the discontinuity is reduced on a time axis of the CC signal. That is, in addition to the partial interference avoidance band, the interference suppression effect can also be obtained outside the partial interference avoidance band, and the interference is further reduced with respect to the primary system.

This is attributed to the following fact that, when the discontinuity is reduced on a time axis of the CC signal, an attenuation characteristic of the sidelobe component of the CC signal becomes steep on the frequency axis, and interference power spectrum density of the CC signal is reduced outside the partial interference avoidance band.

When the signal processing including the waveform shaping is performed to the whole region of the transmitting signal (transmission information OFDM symbol+CC signal OFDM symbol), a distortion is generated in the transmission information OFDM symbol to degrade a transmission characteristic. However, because the CC signal OFDM symbol does not directly affect the transmission characteristic, the OFDM symbol can be waveform-shaped while the degradation of the transmission characteristic is suppressed. Therefore, in the second embodiment, only the CC signal is cut out, and the waveform shaping is performed independently of the transmission information symbol.

In the second embodiment, when the amount of interference with the primary system is kept constant, the increase of the transmission power is suppressed in the secondary system or the spatial distance between the primary system and the secondary system is decreased.

In the second embodiment, it is assumed that the secondary system conducts communication using the frequency except the operating band of the primary system. The interference power spectrum density outside the transmission band of the secondary-system transmitter is increased with increasing power density in the transmission band of the secondary-system transmitter. This is attributed to the following fact that, assuming that the interference amount in which the secondary-system transmitter affects the primary-system receiver is kept constant, the power density can be increased in the transmission band of the secondary-system transmitter by the effect of the second embodiment (that is, effect that the secondary-system transmitter suppresses the interference power spectrum density outside the transmission band). Assuming that the interference amount in which the secondary-system transmitter affects the primary-system receiver is kept constant, a positional relationship (short distance) in which propagation losses of the secondary-system transmitter and the primary-system receiver is permitted by the effect of the second embodiment.

### Third Embodiment

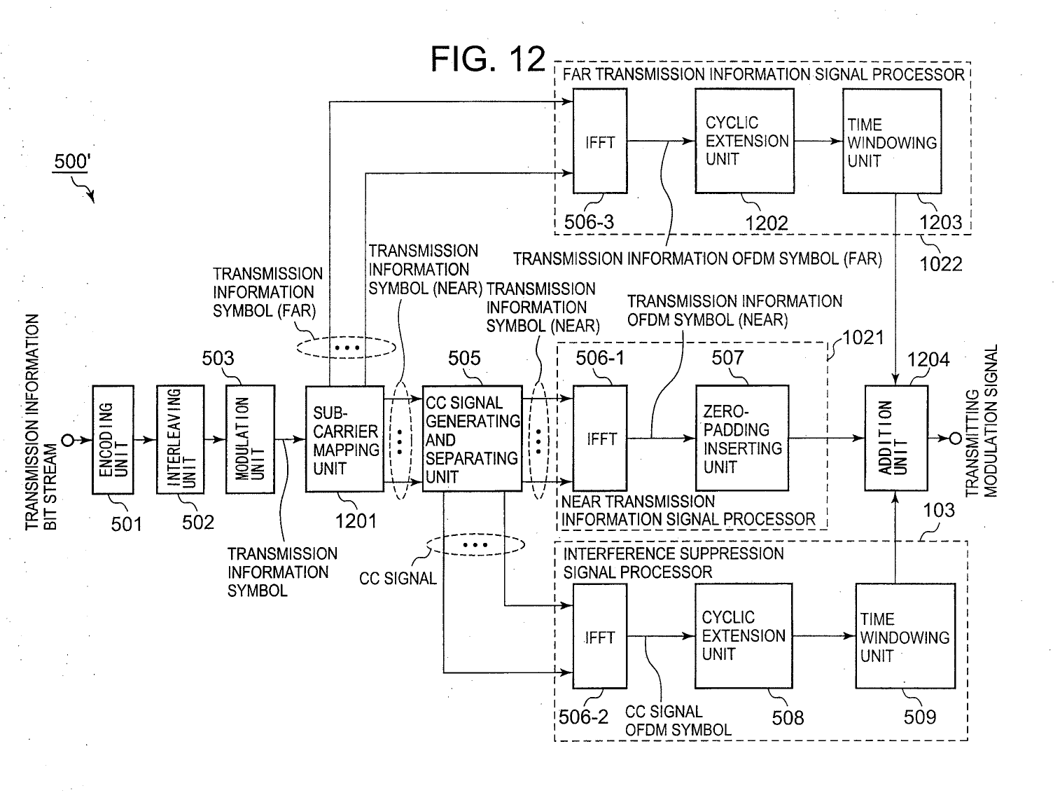

A third embodiment of the invention will be described below. The third embodiment is a modification of the second embodiment illustrated in FIG. 3. Only a portion different from the second embodiment will be described below. FIG. 12 is a block diagram illustrating a configuration example of a baseband unit 500′, which is included in a wireless transmitting apparatus of the third embodiment to perform the digital processing.

In the baseband unit 500′ illustrated in FIG. 12, an IFFT PROCESSING UNIT 506-3, a cyclic extension unit 1202, and a time windowing unit 1203 are added to the configuration of the baseband unit 500 of the second embodiment illustrated in FIG. 3. A sub-carrier mapping unit 1201 is also provided instead of the sub-carrier mapping unit 504 of the baseband unit 500 of the second embodiment. An addition unit 1204 is provided instead of the addition unit 510.

The sub-carrier mapping unit 1201 inputs the modulated transmission information symbol from the modulation unit 503, and performs the S/P conversion to convert the input transmission information symbol into the parallel signal having a predetermined unit (for example, transmission frame unit). The sub-carrier mapping unit 1201 outputs the transmission information symbol, which is frequency-mapped near the interference avoidance band in the transmission information symbol frequency-mapped through the S/P conversion, to the CC signal generating and separating unit 505. The sub-carrier mapping unit 1201 also outputs the transmission information symbol, which is frequency-mapped far away from the interference avoidance band in the frequency-mapped transmission information symbol, to the IFFT PROCESSING UNIT 506-3.

The IFFT PROCESSING UNIT 506-3 inputs the transmission information symbol (the transmission information symbol frequency-mapped far away from the interference avoidance band in the transmission band) output from the sub-carrier mapping unit 1201, and performs the IFFT processing to the input transmission information symbol to generate the OFDM symbol. The IFFT PROCESSING UNIT 506-3 outputs the IFFT-processed transmission information OFDM symbol, which is located far away from the interference avoidance band, to the cyclic extension unit 1202.

The cyclic extension unit 1202 inputs the OFDM symbol (the transmission information OFDM symbol frequency-mapped far away from the interference avoidance band) output from the IFFT PROCESSING UNIT 506-3. The cyclic extension unit 1202 performs the cyclic extension processing of extending the OFDM symbol in the time domain to the input OFDM symbol. The cyclic extension unit 1202 outputs the extended OFDM symbol to which the cyclic extension processing is performed to the time windowing unit 1203.

The time windowing unit 1203 inputs the extended OFDM symbol (the transmission information extended OFDM symbol frequency-mapped far away from the interference avoidance band) output from the cyclic extension unit 1202, and performs the waveform shaping to the input extended OFDM symbol through the window function processing in the time domain. That is, the time windowing unit 1203 performs predetermined third signal processing including the waveform shaping processing to the far transmission information symbol. The time windowing unit 1203 outputs the waveform-shaped extended OFDM symbol to the addition unit 1204. The time windowing unit 1203 differs from the time windowing unit 509 in a waveform shaping characteristic. For example, the time windowing unit 1203 performs the waveform shaping to not the OFDM symbol interval but the CP interval and the tail interval.

For example, a waveform shaping characteristic g(t) of a sample t is expressed by the following equation (8). In the equation (8), N_{FFT} designates the FFT size.

$$\begin{matrix} [ Formula 5 ] & equation ( 8 ) \\ g ( t ) = \{ \begin{matrix}\frac{1}{2} + \frac{1}{2} cos ( π + \frac{π}{{L}_{OV}} ) , & 0 \leq t < {L}_{OV} \\ 1 , & {L}_{OV} \leq t < {L}_{CP} + {N}_{FFT} \\ \frac{1}{2} + \frac{1}{2} cos ( \frac{π ( t - ( \begin{matrix}{L}_{CP} + \\ {N}_{FFT}\end{matrix} ) )}{{L}_{OV}} ) , & \begin{matrix}{L}_{CP} + {N}_{FFT} \leq t < {L}_{CP} + \\ {N}_{FFT} + {L}_{OV}\end{matrix}\end{matrix} & equation ( 8 )\end{matrix}$$

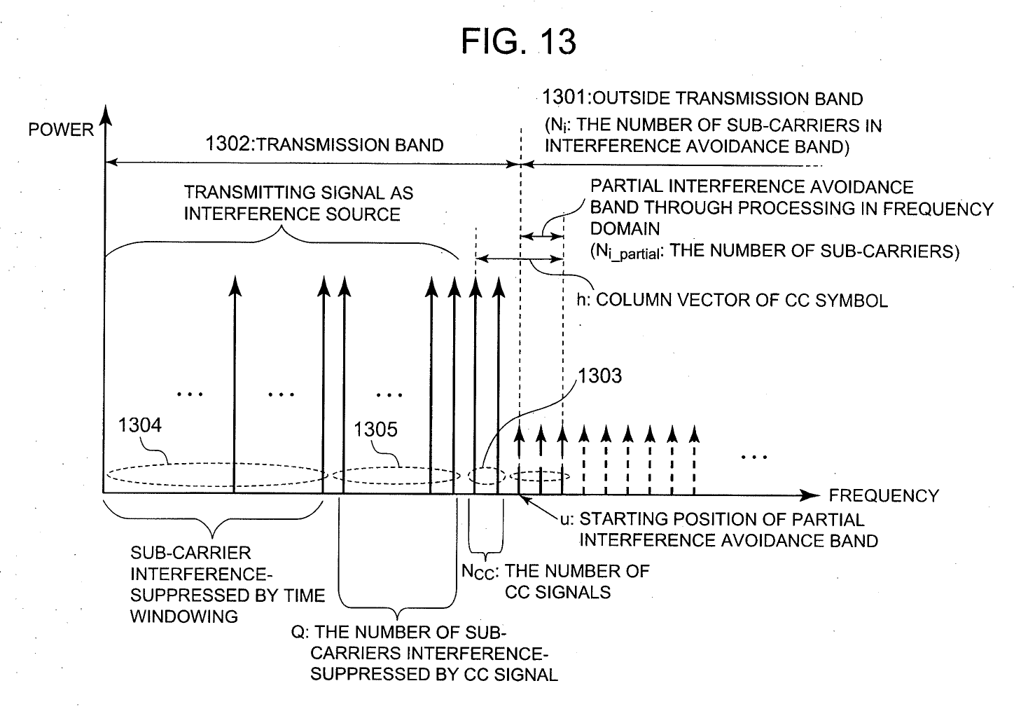

FIG. 13 is an explanatory view illustrating an example of the interference suppression of the third embodiment. In the third embodiment, as illustrated in FIG. 13, through the time windowing, the interference suppression is performed to a transmitting sub-carrier 1304 that is the interference source far away from an interference avoidance band 1301 in the transmission band 1302. The interference suppression is performed to Q transmitting sub-carriers 1305, which are the interference source near the interference avoidance band 1301 in the transmission band 1302, by the same CC system as the first and second embodiments. That is, predetermined fourth signal processing is performed to the near transmission information symbol. In the case that the interference suppression is performed by the CC system, N_{CC} CC signals 1303 waveform-shaped in the time domain are inserted in the transmission band 1302 adjacent to the interference avoidance band 1301. The CC signal 1303 suppresses the partial interference avoidance band corresponding to the Nᵢ_{_{—}}ₚₐᵣₜᵢₐₗ sub-carriers near the transmission band 1302 in the interference avoidance band 1301 corresponding to the Nᵢ sub-carriers.

FIG. 13 illustrates the example in which the interference suppression is performed by the CC system to the Q sub-carriers 1305, which are located near the interference avoidance band 1301 in the sub-carriers in the transmission band 1302 that becomes the interference source, while the interference suppression is performed by the time windowing to other sub-carriers 1304.

The addition unit 1204 inputs the transmission information OFDM symbol, which is located near the interference avoidance band while the zero-padding guard interval is added, from the zero-padding inserting unit 507, inputs the waveform-shaped CC signal extended OFDM symbol from the time windowing unit 509, and inputs the waveform-shaped transmission information extended OFDM symbol, which is located far away from the interference avoidance band, from the time windowing unit 1203. The addition unit 1204 adds the three input signals and outputs the sum as the transmitting modulation signal.

In the third embodiment, the interference suppression signal processing unit 103 includes the IFFT PROCESSING UNIT 506-2, the cyclic extension unit 508, and the time windowing unit 509. A transmission information (near) signal processor 1021 includes the IFFT PROCESSING UNIT 506-1 and the zero-padding inserting unit 507. A transmission information (far) signal processor 1022 includes the IFFT PROCESSING UNIT 506-3, the cyclic extension unit 1202, and the time windowing unit 1203. In the third embodiment, at least the transmission information (near) signal processor 1021 corresponds to the transmission information signal processing unit 102. The transmission information signal processing unit 102 may be constructed by combining the transmission information (near) signal processor 1021 and the transmission information (far) signal processor 1022.

As described above, in the third embodiment, similarly to the second embodiment, the CC signal is processed using the window function, thereby reducing the discontinuity of the CC signal in the time domain. Accordingly, not only the interference suppression effect is obtained in the partial interference avoidance band and the outside of the partial interference avoidance band, but also the high interference suppression effect is obtained outside the partial interference avoidance band by performing the window function processing to the transmission information sub-carrier that is frequency-mapped far away from the interference avoidance band.

In the third embodiment, the signal processing including the waveform shaping is performed to the transmission information sub-carrier that is frequency-mapped far away from the interference avoidance band. However, the waveform shaping is performed to not the OFDM symbol interval, but only the CP interval and the tail interval. Therefore, the higher interference suppression effect is obtained outside the partial interference avoidance band while the degradation of the transmission characteristic is prevented.

By way of example, the different IFFT signal processing systems (the processor from the IFFT PROCESSING UNIT 506-3 and the processor from the IFFT PROCESSING UNIT 506-2) perform the signal processing to the CC signal 1303 and the transmitting sub-carrier 1304, which is frequency-mapped far away from the interference avoidance band, respectively. Alternatively, the same IFFT signal processing system may perform the signal processing to the CC signal 1303 and the transmitting sub-carrier 1304 that is frequency-mapped far away from the interference avoidance band.

In the third embodiment, the interference suppression transmission system in which the processing is performed to the OFDM symbol of the transmitting sub-carrier 1305 frequency-mapped near the interference avoidance band in the frequency domain is not limited to the CC system, but another system may be adopted. The interference suppression transmission system in which the processing is performed to the OFDM symbol of the transmitting sub-carrier 1304 frequency-mapped far away from the interference avoidance band in the time domain and the interference suppression transmission system in which the processing is performed to the CC signal OFDM symbol in the time domain are not limited to the time windowing, but another system may be adopted.

In the first to third embodiments, the OFDM wireless transmitting apparatus in the multi-carrier transmission is described by way of example. Alternatively, for example, the configurations of the first to third embodiments may also be applied to a DFT (Discrete Fourier Transform)-Spread OFDM in a single-carrier transmission.

In the first to third embodiments, the wireless transmitting apparatus of the invention is applied to the secondary system. Alternatively, the configurations of the first to third embodiments may also be applied to a wireless transmitting apparatus (for example, a secondary-system base station and a secondary-system mobile station) included in the primary system.

For example, the configuration of each of the baseband units in the first to third embodiments may be constructed as a hardware circuit. For example, the configuration of each of the baseband units may be constructed by a computer circuit (for example, a CPU (Central Processing Unit)) that is operated according to a control program. In this case, the control program is stored in a storage medium (such as a ROM (Read Only Memory) and a hard disk) of the wireless transmitting apparatus or the baseband unit or an external storage medium (such as a removable medium and a removable disk) and read by the computer circuit.

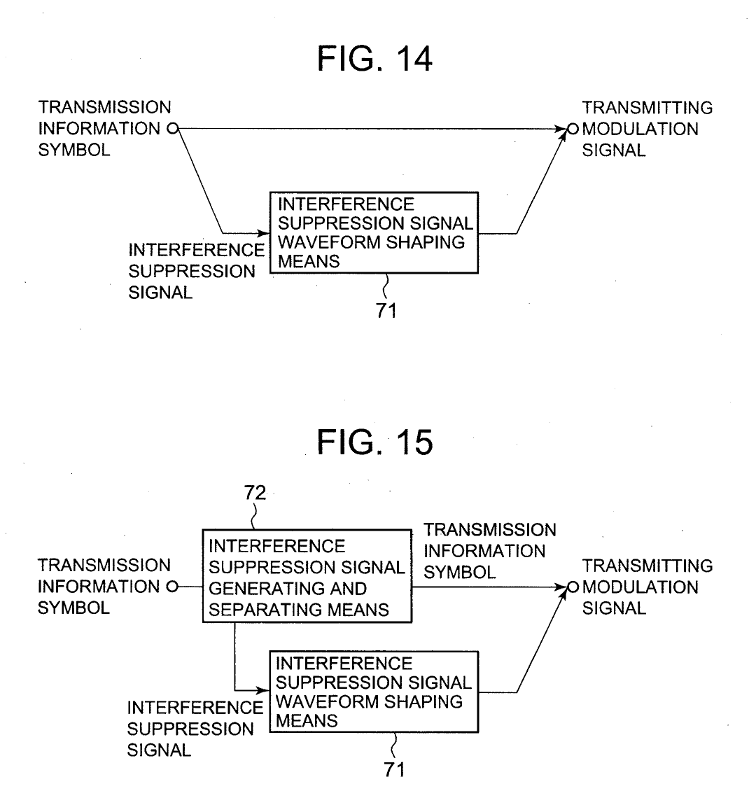

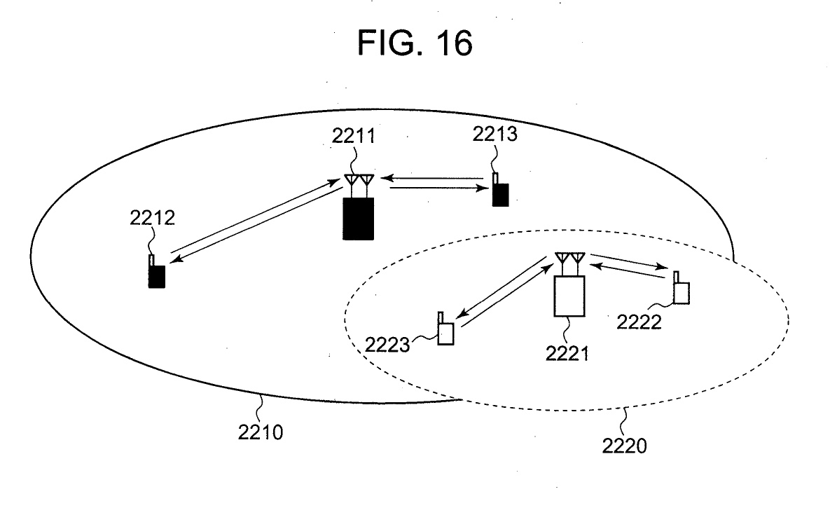

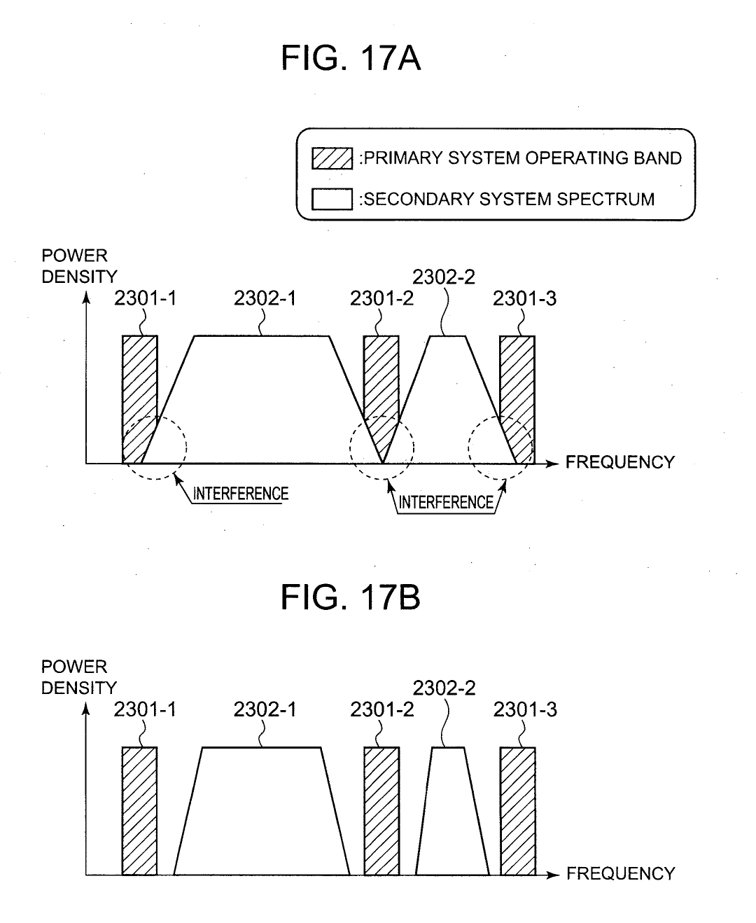

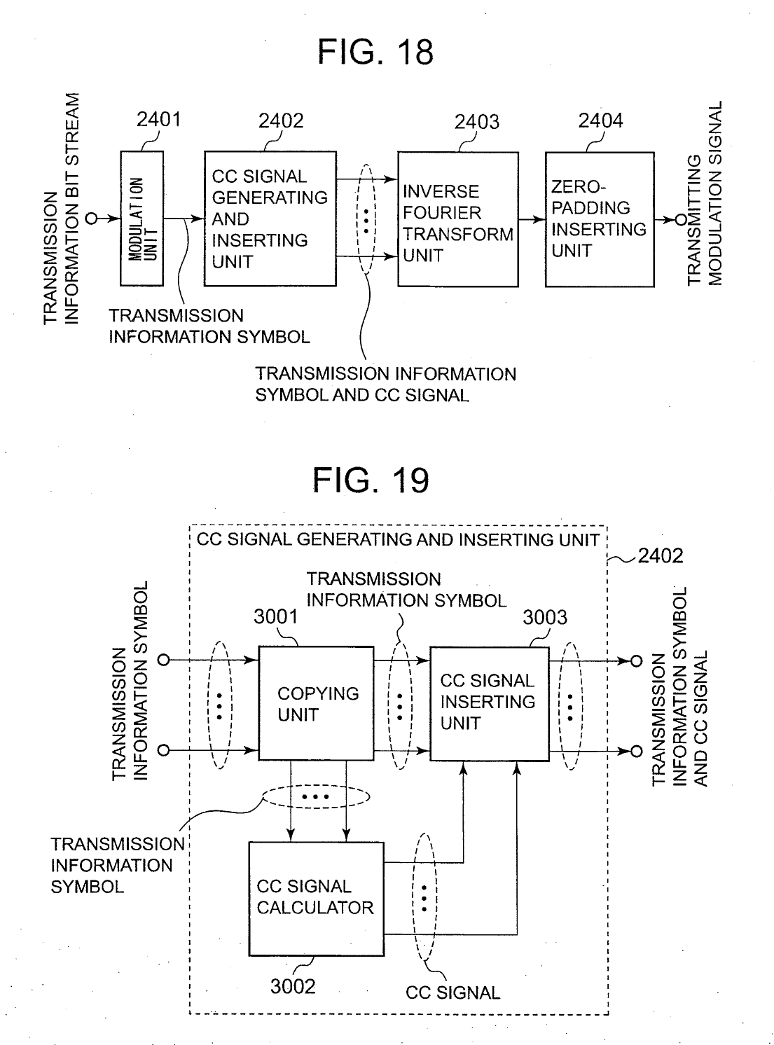

An outline of an illustrative embodiment will be described below. FIGS. 14 and 15 are block diagrams illustrating the outline of the illustrative embodiment. As illustrated in FIG. 14, the wireless transmitting apparatus of the invention includes interference suppression signal waveform shaping means 71. The interference suppression signal waveform shaping means 71 performs the waveform shaping to the interference suppression signal that suppresses a leakage power caused by the transmission information symbol outside the desired transmission band, while the interference suppression signal is separated from the transmission information symbol. In the first to third embodiments, for example, the interference suppression signal waveform shaping means 71 corresponds to the interference suppression signal processing unit 103 and the time windowing unit 509.

For example, the interference suppression signal waveform shaping means 71 performs the waveform shaping to the interference suppression signal using the window function in the time domain.

As illustrated in FIG. 15, the wireless transmitting apparatus of the invention may further include interference suppression signal generating and separating means 72. The interference suppression signal generating and separating means 72 inputs the transmission information symbol, generates the interference suppression signal that suppresses the leakage power caused by the input transmission information symbol outside the desired transmission band, and outputs the input transmission information symbol and the generated interference suppression signal while the transmission information symbol and the interference suppression signal are separated. In the first to third embodiments, for example, the interference suppression signal generating and separating means 72 corresponds to the interference suppression signal generating and separating unit 101.

The wireless transmitting apparatus of the invention may include: interference suppression signal generating and separating means (for example, interference suppression signal generating and separating unit 101) for inputting the transmission information symbol, generating the interference suppression signal that suppresses the leakage power caused by the input transmission information symbol outside the desired transmission band, and outputting the input transmission information symbol and the generated interference suppression signal while the transmission information symbol and the interference suppression signal are separated; transmission information signal processing means (for example, transmission information signal processing unit 102) for inputting the transmission information symbol supplied from the interference suppression signal generating and separating means, and performing the predetermined signal processing to the input transmission information symbol; interference suppression signal processing means (for example, interference suppression signal processing unit 103) for inputting the interference suppression signal supplied from the interference suppression signal generating and separating means, and performing the predetermined signal processing including the waveform shaping to the input interference suppression signal; and synthesizing means (for example, synthesizing unit 104) for inputting a transmission information signal that is supplied from the transmission information signal processing means and obtained as a result of predetermined signal preprocessing to the transmission information symbol and the waveform shaping interference suppression signal that is supplied from the interference suppression signal processing means and obtained as a result of the predetermined signal processing including the waveform shaping to the interference suppression signal, and synthesizing the input transmission information signal and the waveform shaping interference suppression signal. In the case that the wireless transmitting apparatus has the above configuration, the interference suppression signal waveform shaping means 71 is mounted as the interference suppression signal processing means on the wireless transmitting apparatus.

The transmission information signal processing means may include: first inverse Fourier transform means (for example, IFFT PROCESSING UNIT 506-1) for performing the inverse Fourier transform to the input transmission information symbol to generate the OFDM symbol; and zero-padding inserting means (for example, zero-padding inserting unit 507) for adding the zero-padding guard interval to the OFDM symbol generated by the first inverse Fourier transform means.

The interference suppression signal processing means may include: second inverse Fourier transform means (for example, IFFT PROCESSING UNIT 506-2) for performing the inverse Fourier transform to the input interference suppression signal to generate the OFDM symbol; first time domain extending means (for example, cyclic extension unit 508) for performing the extension processing in the time domain to the OFDM symbol generated by the second inverse Fourier transform means; and first waveform shaping preprocess means (time windowing unit 509) for performing the waveform shaping processing using the window function in the time domain to the extended OFDM symbol obtained as a result of the extension processing performed by the first time domain extending means.

The first waveform shaping processing means may perform the waveform shaping in the time domain to the extended OFDM symbol based on a roll-off filter characteristic satisfying a first reference of Nyquist.

The wireless transmitting apparatus of the invention may include: sub-carrier mapping means (for example, sub-carrier mapping unit 1201) for inputting the transmission information symbol, and separating the input transmission information symbol into the far transmission information symbol that is frequency-mapped far away from the interference avoidance band in the transmission band and the near transmission information symbol that is frequency-mapped near the interference avoidance band in the transmission band; and far transmission information signal processing means (for example, transmission information (far) signal processor 1022) for inputting the far transmission information symbol supplied from the sub-carrier mapping means, and performing the predetermined signal processing including the waveform shaping to the input far transmission information symbol, wherein the interference suppression signal generating and separating means may input the near transmission information symbol supplied from the sub-carrier mapping means, and generate the interference suppression signal that suppresses the leakage power caused by the near transmission information symbol outside the desired transmission band, and the transmission information signal processing means may input the near transmission information symbol supplied from the interference suppression signal generating and separating means, and perform the predetermined signal processing to the input near transmission information symbol.

In such cases, the wireless transmitting apparatus may include synthesizing means (for example, addition unit 1204) for inputting the near transmission information signal that is obtained as a result of the predetermined signal processing to the near transmission information symbol, the waveform shaping interference suppression signal that is obtained as a result of the predetermined signal processing including the waveform shaping to the interference suppression signal, and the waveform shaping far transmission information signal that is obtained as a result of the predetermined signal processing including the waveform shaping to the far transmission information symbol, and synthesizing the input transmission information signal and the waveform shaping interference suppression signal.

For example, the far transmission information signal processing means includes third inverse Fourier transform means (for example, IFFT PROCESSING UNIT 506-3) for performing the inverse Fourier transform to the input far transmission information symbol to generate the OFDM symbol; second time domain extending means (for example, cyclic extension unit 1202) for performing the extension processing in the time domain to the OFDM symbol generated by the third inverse Fourier transform means; and second waveform shaping processing means (time windowing unit 1203) for performing the waveform shaping processing using the window function in the time domain to the extended OFDM symbol that is obtained as a result of the extension processing performed by the second time domain extending means.

The invention can suitably be applied to the apparatus, method, and program, which need to transmit the wireless signal while the interference with the band except the transmission band is suppressed.

While the invention has been particularly shown and described with reference to illustrative embodiments thereof, the invention is not limited to these embodiments. It will be understood by those of ordinary skill in the art that various changes in form and details may be made therein without departing from the spirit and scope of the present invention as defined by the claims.

What is claimed is:

1. A wireless transmitting apparatus comprising:
an interference suppression signal waveform shaping unit which performs waveform shaping to an interference suppression signal that suppresses a leakage power caused by a transmission information symbol outside a desired transmission band and separates the interference suppression signal and the transmission information symbol.

2. The wireless transmitting apparatus according to claim 1, wherein the interference suppression signal waveform shaping unit performs the waveform shaping to the interference suppression signal using a window function in a time domain.

3. The wireless transmitting apparatus according to claim 1, further comprising:
an interference suppression signal generating and separating unit which outputs the input transmission information symbol and the generated interference suppression signal while separating the transmission information symbol and the interference suppression signal;
a transmission information signal processing unit which generates a transmission information signal by performing predetermined first signal processing to the transmission information symbol input from the interference suppression signal generating and separating unit;
an interference suppression signal processing unit which generates a waveform shaping interference suppression signal by performing predetermined second signal preprocessing including waveform shaping processing to the interference suppression signal input from the interference suppression signal generating and separating unit; and
a synthesizing unit which synthesizes the transmission information signal and the waveform shaping interference suppression signal.

4. The wireless transmitting apparatus according to claim 2, wherein the window function is performed on at least signals between transmission information OFDM symbols.

5. The wireless transmitting apparatus according to claim 3, wherein the transmission information signal processing unit includes:
a first inverse Fourier transform processing unit which generates an OFDM symbol by performing an inverse Fourier transform to the transmission information symbol; and
a zero-padding inserting unit which adds a zero-padding guard interval to the OFDM symbol generated by the first inverse Fourier transform unit.

6. The wireless transmitting apparatus according to claim 3, the interference suppression signal processing unit includes:
a second inverse fast Fourier transform unit which generates the OFDM symbol by performing the inverse Fourier transform to the interference suppression signal;
a first time domain extending unit which performs extension processing in the time domain to the OFDM symbol generated by the second inverse Fourier transform unit; and
a first waveform shaping processing unit which performs waveform shaping processing using the window function in the time domain to the extended OFDM symbol obtained as a result of the extension processing.

7. The wireless transmitting apparatus according to claim 6, wherein the first waveform shaping processing unit performs the waveform shaping processing in the time domain based on a roll-off characteristic satisfying a first reference of Nyquist.

8. The wireless transmitting apparatus according to claim 3, further comprising:
a sub-carrier mapping unit which separates the input transmission information symbol into a far transmission information symbol that is frequency-mapped whose distance from an interference avoidance band in a transmission band is more than a predetermined threshold and a near transmission information symbol that is frequency-mapped whose distance from the interference avoidance band in the transmission band is less than the predetermined threshold; and
a far transmission information signal processing unit which performs predetermined third signal processing including waveform shaping processing to the far transmission information symbol,
wherein the interference suppression signal generating and separating unit generates a signal that suppresses a leakage power caused by the near transmission information symbol outside the desired transmission band as the interference suppression signal, and
the transmission information signal processing unit inputs the near transmission information symbol supplied from the interference suppression signal generating and separating unit, and performs predetermined fourth signal processing to the input near transmission information symbol.

9. The wireless transmitting apparatus according to claim 8, further comprising,
a synthesizing unit which inputs the near transmission information signal that is supplied from the transmission information signal processing unit and obtained as a result of the fourth signal processing, a waveform shaping interference suppression signal that is obtained as a result of the second signal processing, and a waveform shaping far transmission information signal that is supplied from the far transmission information signal processing unit and obtained as a result of the third signal processing, and synthesizing the input transmission information signal and the waveform shaping interference suppression signal.

10. A wireless transmitting method comprising:
performing waveform shaping to an interference suppression signal that suppresses a leakage power caused by a transmission information symbol outside a desired transmission band; and
separating the interference suppression signal from the transmission information symbol.

11. A computer readable information storage medium storing a program that causes a computer to perform processing comprising:
performing waveform shaping to an interference suppression signal that suppresses a leakage power caused by a transmission information symbol outside a desired transmission band; and
separating the interference suppression signal and the transmission information symbol.
